(19) United States
(12) Patent Application Publication
(10) Pub. No.: US 2025/0029079 A1
(43) Pub. Date: Jan. 23, 2025

(54) PROVIDING OPTIONS FOR COMPLETING A REQUEST FOR PAYMENT

(71) Applicant: Wells Fargo Bank, N.A., San Francisco, CA (US)

(72) Inventors: Brent Teitel, Armonk, NY (US); Michelle Emily Ziolkowski, Pittsburgh, PA (US)

(21) Appl. No.: 17/818,245

(22) Filed: Aug. 8, 2022

(51) Int. Cl. G06Q 20/10; G06Q 40/02

(52) U.S. Cl. CPC G06Q 20/102; G06Q 40/03

(57) ABSTRACT

A computing system includes a memory and processing circuitry in communication with the memory. The processing circuitry is configured to receive, from a biller device, a request for payment that indicates a payment amount requested from a payer; and output, for display by a payer device operated by the payer, information indicative of the request for payment, wherein the information indicative of the request for payment comprises the requested payment amount. The processing circuitry is also configured to output, for display by the payer device, information about an offer to apply a funding option to the payment amount, wherein the offer to apply the funding option identifies an amount of funds available; and receive, from the payer device, an indication of selection of the funding option.

### TECHNICAL FIELD

The disclosure relates to computing systems, and more specifically, computing systems that handle requests for payment.

### BACKGROUND

Network-connected devices can be used to complete transactions and pay bills. Typically, a “payer” transfers funds to a “biller” from an account held by the payer in order to pay a bill or complete a transaction. To complete a payment that is larger than an outstanding balance of an account, the payer may in some cases transfer funds from another account, use one or more existing lines of credit, or apply for new credit, or access other sources of funding.

### SUMMARY

In general, this disclosure describes techniques for providing funding options enabling “payers” to pay a bill, make a payment, or otherwise transfer funds to a “biller” to satisfy a request for payment. Billers may, in some cases, request payment from payers. In such an example, a biller may cause a request for payment to be sent electronically to a bank, financial institution, or other banking provider that maintains an account held by the payer. The payer may receive, via a banking application executing on a device operated by the payer, a notification about the request for payment from the biller. The request for payment may indicate a requested payment amount and a requested payment date. In response to the request for payment, the payer may arrange for the transfer of funds from an account held by the payer to an account held by the biller.

This disclosure describes techniques that enable the payer to, for example, arrange for or access alternative source of funding, and use such funding options to make a payment. Such funds may, in some cases, be used in addition to (e.g., as a supplement to) funds present in the payer's account. Funding options may include loans, credit lines, transfers from other accounts, and other options.

In at least some examples described herein, a computing system may present, through an application executing on a device operated by a user, funding options that enable the user (i.e., the “payer”) to make a payment to a biller. For example, the computing system may receive a request for payment from a biller that indicates a payment amount requested, and the identity of a payer. In some cases, the payer will hold an account associated with a bill paying service or funds transferring service provided by or associated with the computing system. The computing system may output information indicative of the request for payment. In some cases, such output may take the form of a notification sent to a device operated or possessed by the payer. The notification may be presented via an application executing on the payer device, with the notification indicating that the biller requests payment. The payer may view the request for payment via the application, the request indicating a requested payment amount and a requested payment date.

In some examples, the computing system may output one or more funding options for completing a request for payment to the payer. The one or more funding options may serve as alternative sources of payment. When a biller requests a payment for an amount that is greater than a balance present in the payer's account, for example, the payer may access these alternative funding options in order to pay the bill and thereby complete the request for payment by the requested payment date. The computing system may, in some examples, identify one or more funding options available to the payer and output these options for display by a device operated by the A payer. For example, the computing system may output an offer to extend a loan to the payer. The offer to extend a loan may include one or more loan amounts selectable by the payer.

It may sometimes be beneficial to output information about the alternative sources of payment (or alternative funding options) that allows the payer to compare such alternative sources of payment to other funding options. For example, the computing system may output information indicating a fee associated with a loan corresponding to one funding option, and information indicating a repayment plan for the loan. The computing system may convert the fee associated with the loan into an annual percentage rate (APR) so that the payer can compare the APR for the loan against an APR of a credit line available to the payer. Additionally, or alternatively, the computing system may output information indicative of a late fee that becomes due when the request for payment is not completed by a requested date. By outputting information concerning the offer to extend the loan, the late fee, and the information concerning one or more other lines of credit, the payer may more readily understand the actual financial effect of available options (e.g., including missing a payment), and may also enable the payer to select the most prudent or cheapest option for completing the request for payment based on the information.

The computing system may, in some cases, output an option to apply one or more rewards balances to a request for payment sent by a biller. Often consumers maintain loyalty accounts with various retailers or commercial enterprises, and a payer may therefore possess rewards balances in various forms. For example, the payer may possess a rewards balance with the biller and/or a rewards balance with a financial institution that maintains an accounts held by the payer. The computing system may identify one or more rewards balances possessed by the payer and output an option to apply the one or more rewards balances towards the requested amount of the request for payment. In some examples, the one or more rewards balances may be less than the requested payment amount. In these examples, the payer may access or pursue funding options in addition to applying the one or more rewards balances.

In one example, a computing system includes a memory and processing circuitry in communication with the memory. The processing circuitry is configured to receive, from a biller device, a request for payment that indicates a payment amount requested from a payer; and output, for display by a payer device operated by the payer, information indicative of the request for payment, wherein the information indicative of the request for payment comprises the requested payment amount. The processing circuitry is also configured to output, for display by the payer device, information about an offer to apply a funding option to the payment amount, wherein the offer to apply the funding option identifies an amount of funds available; and receive, from the payer device, an indication of selection of the funding option.

In another example, a method includes receiving, by processing circuitry from a biller device, a request for payment that indicates a payment amount requested from a payer; and outputting, by the processing circuitry for display by a payer device operated by the payer, information indicative of the request for payment, wherein the information indicative of the request for payment comprises the requested payment amount. Additionally, the method includes outputting, by the processing circuitry for display by the payer device, information about an offer to apply a funding option to the payment amount, wherein the offer to apply the funding option identifies an amount of funds available; and receiving, by the processing circuitry from the payer device, an indication of selection of the funding option.

In another example, a non-transitory computer readable medium comprising instructions that when executed cause one or more processors to: receive, from a biller device, a request for payment that indicates a payment amount requested from a payer; and output, for display by a payer device operated by the payer, information indicative of the request for payment, wherein the information indicative of the request for payment comprises the requested payment amount. Additionally, the instructions cause the one or more processors to output, for display by the payer device, information about an offer to apply a funding option to the payment amount, wherein the offer to apply the funding option identifies an amount of funds available; and receive, from the payer device, an indication of selection of the funding option.

The summary is intended to provide an overview of the subject matter described in this disclosure. It is not intended to provide an exclusive or exhaustive explanation of the systems, device, and methods described in detail within the accompanying drawings and description below. Further details of one or more examples of this disclosure are set forth in the accompanying drawings and in the description below. Other features, objects, and advantages will be apparent from the description and drawings, and from the claims.

### BRIEF DESCRIPTION OF DRAWINGS

FIG. 1 is a block diagram illustrating a network that includes a computing system 10, a set of biller devices, and a set of payer devices, in accordance with one or more techniques of this disclosure.

FIG. 2 is a conceptual diagram illustrating a request for payment screen for display on a user interface of a device, in accordance with one or more techniques of this disclosure.

FIG. 3 is a conceptual diagram illustrating a funding option comparison and information screen for display on a user interface of a device, in accordance with one or more techniques of this disclosure.

FIG. 4 is a conceptual diagram illustrating a loan offer information screen for display on a user interface of a device, in accordance with one or more techniques of this disclosure.

FIG. 5 is a conceptual diagram illustrating an autopay option screen for display on a user interface of a device, in accordance with one or more techniques of this disclosure.

FIG. 6 is a conceptual diagram illustrating a terms and conditions screen for display on a user interface of a device, in accordance with one or more techniques of this disclosure.

FIG. 7 is a conceptual diagram illustrating a confirmation screen for display on a user interface of a device, in accordance with one or more techniques of this disclosure.

FIG. 8 is a flow diagram illustrating an example method for outputting one or more funding options for completing a request for payment, in accordance with one or more techniques of this disclosure.

### DETAILED DESCRIPTION

A clearing house is a financial institution that manages funds transfers, such as funds transfers between banks, member firms, and/or firms associated with the clearing house. One long-standing clearing house in the United States is “The Clearing House” or “TCH.” TCH is a banking association and payments company owned by large commercial banks in the United States. TCH is the parent organization of The Clearing House Payments Company L.L.C., which operates core payments system infrastructure in the United States, including infrastructure enabling ACH, wire payments, check image clearing, and real-time payments through TCH's real-time payments (“RTP”) network.

The RTP network enables banks and/or federally insured U.S. depository institutions to collect payments through mobile technology and digital commerce. In particular, one RTP service, known as Request for Payment (“RfP”), enables billers to send a bill to a customer (a “payer”) and enables that customer/payer to pay the bill. For example, in a typical RfP flow, a consumer or small business (i.e., a “payer”) receives a text message, email, mobile app alert, or other communication that was initiated by a biller. The communication informs the payer that the payer has a bill payment coming due. Generally, the communication includes details about the bill, enabling the payer to review the bill and verify its accuracy. The payer can then respond to the communication by paying the bill in full or making a partial payment. The payer can usually also choose to pay the bill immediately or schedule the payment. When the payment is sent from the payer's checking account, it is generally received immediately by the biller, often with all the necessary payment details to facilitate immediate reconciliation. The payer can also see virtually immediate confirmation that the bill has been paid.

The foregoing RfP example is described in a bill pay context, and at least some other examples described herein are described in a similar context. However, RfP can be used for other purposes, such as account opening, account to account transfers, small business e-invoicing, simplified payables, and other contexts. Accordingly, techniques described herein are not limited to the bill pay context, and may apply to other contexts as well.

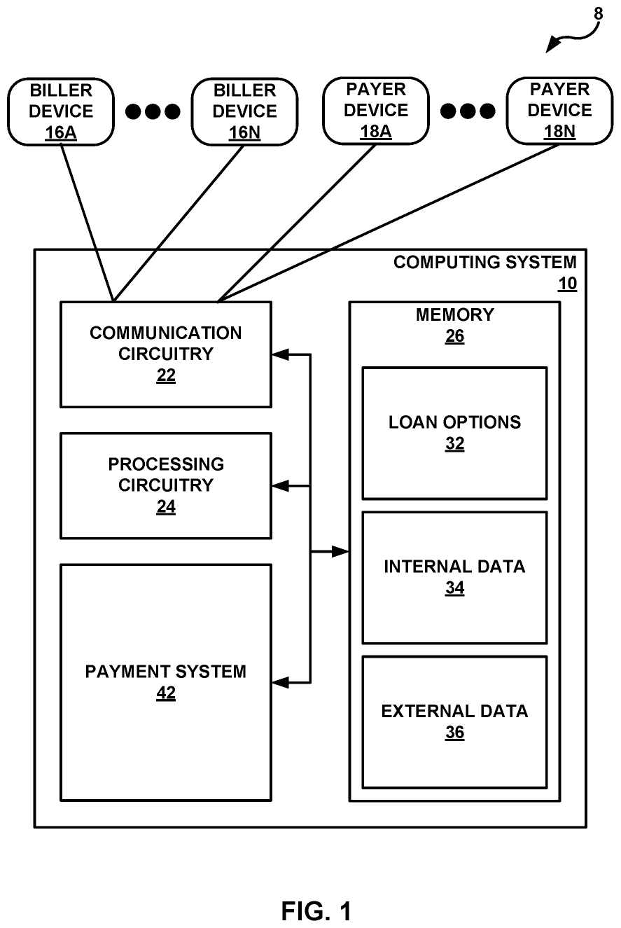

FIG. 1 is a block diagram illustrating a network 8 that includes a computing system 10, a set of biller devices 16A-16N, and a set of payer devices 18A-18N, in accordance with one or more techniques of this disclosure. As seen in FIG. 1, computing system 10 includes communication circuitry 22, processing circuitry 24, and memory 26. Memory 26 may be configured to store loan options 32, internal data 34, and external data 36. Computing system 10 may include payment system 42.

In the context of FIG. 1, and as described above (and elsewhere herein), a biller may directly request payment from a banking customer via a banking application used by a banking customer. Also as described above, such a request may be referred to herein as a “requests for payment,” or “RfP.” To send the RfP, a computing device operated by the biller may send the RfP to a clearing house (e.g., TCH), and the clearing house may send the request for payment to a banking application executing on a computing device operated by the banking customer/payer. When the computing device operated by the payer receives the request for payment, the computing device presents information about the bill (e.g., through an alert), enabling the payer to review the bill and prompting the payer to complete payment from a linked account (e.g., a checking account or a savings account that the payer holds at the banking customer's bank).

By facilitating requests for payment, the clearing house may enable a biller who banks with a first member firm of the clearing house to send a request for payment to a payer who banks with a second member firm of the clearing house. The clearing house receives the request for payment from the biller and relays the request for payment to the payer in some way, such as through an app developed and distributed by the payer's bank. This may enable billers to send RfPs to any payer that known to the clearing house, such as by having an account with at least one member firm of the clearing house.

In examples described herein, computing system 10 often represents a system that manages one or more customer accounts within a financial institution such as a commercial bank. In some examples, the financial institution corresponding to computing system 10 may be a member firm of a clearing house. The financial institution corresponding to computing system 10 may exchange funds with other member firms of the clearing house. For example, computing system 10 may receive an RfP from a biller via the clearing house, the RfP with the RfP identifying a payer that holds one or more accounts managed and/or maintained a financial institution that operates computing system 10.

In other examples, however, computing system 10 may represent a computing system operated by a clearing house. In yet another example, computing system 10 may represent distributed computing system that includes computing systems operated by multiple entities, including additional financial institutions and/or by one or more clearing houses.

Accordingly, computing system 10 may be implemented through any suitable computing infrastructure, and such computing infrastructure may be controlled by one or more different financial institutions, clearing houses, and/or other entities. Such computing infrastructure may include one or more server computers, workstations, mainframes, appliances, cloud computing systems, and/or other computing devices that may be capable of performing operations and/or functions described in accordance with one or more aspects of the present disclosure. Such computing systems may represent or be implemented through one or more virtualized compute instances (e.g., virtual machines, containers) of a data center, cloud computing system, server farm, and/or server cluster. Such computing systems may be distributed across multiple data centers, server farms, and/or clouds, and may be controlled by one or more different financial institutions, clearing houses, and/or other entities. In an example that can be described in the context of FIG. 1, computing system 10 may be configured to receive a request for payment from a biller via a clearing house. Computing system 10 may output the request for payment to the payer. In some examples, the payer has the option to respond to the RfP by transferring funds to the biller from one or more accounts held by the payer. But in some cases, the payer may seek options for funds in addition to funds present in the one or more accounts. For example, the payer may choose to pay the bill using funding options that may include a personal loan or one or more credit cards. In some cases, computing system 10 may identify one or more funding options for completing the request for payment (i.e., paying the bill) that include funds in addition to funds present in one or more accounts held by the payer. Computing system 10 may include the one or more funding options when outputting the RfP to a device operated by the payer.

A communication that serves as a request for payment may, in some cases, identify a payer, a requested payment amount, and a requested payment date. The request for payment may, in some examples, represent a request for the payer to provide the requested payment amount to the biller by the requested payment date. There may be consequences if the payer does not provide the requested payment amount by the requested payment date. For example, a late fee may be added to the requested payment amount if the request for payment is not completed by the requested payment date. This may prompt a payer to seek funding options to complete the request for payment if the payer does not possess sufficient funds to complete the request for payment by the requested payment date. By including or inserting one or more funding options with the request for payment (e.g., within the RfP flow), computing system 10 may effectively redirect an existing RfP to a line of credit for payment or provide options for receiving instant funding to use in response to the RfP. Computing system 10 may do so by presenting various funding options and comparable cost to the payer along with the RfP. Such a process may provide the payer with options to seamlessly complete the request for payment and pay a bill on time.

By including one or more funding options with requests for payment, computing system 10 may improve a request for payment experience for both of the biller and the payer as compared with systems that do not include funding options with requests for payment. For example, billers may obtain quicker funds access and experience lower delinquency rates and decreased levels of customer complaints as compared with systems that send requests for payment to payers without funding options. Payers may benefit when one or more funding options are presented with a request for payment, because the payer can choose from the one or more funding options without having to identify these options outside of the request for payment. Payers may also more effectively manage cash flow for varying and unexpected bill increases, and thereby experience fewer late fees and fewer service disruptions as compared with systems that do not include funding options with requests for payment. Financial institutions that provide infrastructure for such a process (e.g., by operating computing system 10 and/or developing a banking app used by a customer device) may also benefit, such as through incremental business for consumer lending.

As described herein, the term “biller” may refer to any party that requests payment from another party. Billers may include both organizations and individuals. As described herein, the term “payer” may refer to any party that receives a request for payment from another party. Payers may include both organizations and individuals. For example, a biller organization may request payment from one or more payer organizations and/or one or more payer individuals. Additionally, or alternatively, a biller individual may request payment from one or more payer organizations and/or one or more payer individuals.

Each of biller devices 16A-16N (collectively, “biller devices 16” and representing any number of biller devices) may be any suitable communication device, computing device, or computing system capable of communicating with computing system 10 and/or other devices. In some cases, one or more of biller devices 16A-16N may be a computing system or set of computing systems operated or controlled by a small or large business or other organization. In some cases, one or more of biller devices 16A-16N may be a mobile device, such as a mobile phone, tablet, or wearable device, such as a device that may be operated by an individual user. In general, biller devices 16 will tend to support communication services over packet-switched networks, e.g., the public internet. In some examples, each of biller devices 16 may be associated with a biller that sends one or more requests for payment to computing system 10 via a clearing house.

Each of payer devices 18A-18M (collectively, “payer devices 18” and representing any number of payer devices) may be any suitable communication device, computing device, or computing system capable of communicating with computing system 10 and/or other devices. In some examples, one or more payer devices 18A-18M may be a mobile and/or wearable computing device, such as a mobile phone, tablet, or other device. However, any suitable computing system may be used to implement one or more of payer devices 18A-18M, such as a desktop or laptop computing device, workstation, or otherwise. Like biller devices 16A-16N, payer devices 18 will tend to support communication services over packet-switched networks, e.g., the internet. In some examples, each of payer devices 18 may be operated by a payer that receives one or more requests for payment from a biller (e.g., through computing system 10).

Communication circuitry 22 may include any suitable hardware, firmware, software or any combination thereof for communicating with another device, such as any one or combination of biller devices 16, payer devices 18, or another device. Communication circuitry 22 may receive downlink telemetry from, as well as send uplink telemetry to, biller devices 16, payer devices 18, or another device with the aid of an internal or external antenna. In some examples, communication circuitry 22 may include one or more connections for wired links with other devices.

Processing circuitry 24, in some examples, may include one or more processors that are configured to implement functionality and/or process instructions for execution within computing system 10. For example, processing circuitry 24 may be capable of processing instructions stored in memory 26. Processing circuitry 24 may include, for example, microprocessors, digital signal processors (DSPs), application specific integrated circuits (ASICs), field-programmable gate arrays (FPGAs), equivalent discrete or integrated logic circuitry, or a combination of any of the foregoing devices or circuitry. Accordingly, processing circuitry 24 may include any suitable structure, whether in hardware, software, firmware, or any combination thereof, to perform the functions ascribed herein to processing circuitry 24.

Memory 26 may be configured to store information within computing system 10 during operation. The memory may include a computer-readable storage medium or computer-readable storage device. In some examples, the memory includes one or both of a short-term memory or a long-term memory. The memory may include, for example, random access memories (RAM), read-only memories (ROM), compact disc read-only memories (CD-ROM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 26 is used to store program instructions for execution by processing circuitry 24.

Memory 26 may be configured to store loan options 32. Loan options 32 may include one or more loan options that an administrator of computing system 10 may extend to payers. In some examples, each loan option of loan options 32 may include a loan amount, one or more fees associated with the loan option, and a repayment plan associated with the loan option. For example, a loan option may include a loan amount of $500 and a loan fee of $20, meaning that a payer that accepts the loan option must repay $520 to fully repay the loan. The repayment plan for this loan option may include, in some examples, four monthly payments of $130, totaling $520. Each loan option of the loan options 32 may include a custom loan amount, fee, and repayment plan.

Memory 26 may be configured to store internal data 34. The internal data 34 may include data associated with one or more accounts held by payers. The one or more accounts may represent accounts managed by an administrator of computing system 10. The administrator may represent a financial institution, such as a bank. Internal data 34 may include one or more money balances associated with accounts, one or more rewards balances associated with accounts, transaction history associated with accounts, and other kinds of data associated with accounts. In some examples, the internal data 34 may include automatic paycheck deposit data for one or more accounts that indicates an amount of money deposited into a respective account, and a time interval at which the amount of money is deposited. For example, internal data 34 may indicate that $2550 is deposited into an account every two weeks.

Memory 26 may be configured to store external data 36. The external data 36 may include data corresponding to one or more external accounts possessed by payers that also have accounts with the administrator of computing system 10. External data 36 may, for example, include data concerning a payer's account with a biller that sends requests for payment to computing system 10. External data 36 may indicate an amount of money owed to a biller by a payer, and one or more late fees that will apply if the payer does not pay the balance owed by an appointed date. Additionally, or alternatively, external data 36 may include information concerning one or more external lines of credit (e.g., credit cards, personal credit lines) available to payers that also have accounts with the administrator of computing system 10. For example, external data 36 may include data that indicates a payer has access to one or more credit cards, and indicate an APR associated with each of the one or more credit cards.

Processing circuitry 24 may execute payment system 42 in order to perform one or more actions concerning requests for payment. A request for payment is a message sent to a payer from a biller, the message requesting that the payer transfer an amount of money to the biller. To complete a request for payment, the payer reviews the request and agrees to transfer the requested amount of money to the biller. Payment system 42 of computing system may perform one or more actions to facilitate requests for payment. For example, payment system 42 may receive one or more requests for payment from biller devices 16 which correspond to billers and output each request for payment of the one or more requests for payment to a respective payer device of payer devices 18. Payment system 42 may perform one or more actions in addition to conveying information present in a request for payment received by computing system 10 to the payer. For example, payment system 42 may output one or more funding options to the payer. Payment system 42 may output the one or more funding options such that the payer may seamlessly complete the request for payment within an application without needing to evaluate and pursue funding options independently.

Processing circuitry 24 may control payment system 42 to receive, from a biller device of biller devices 16 (e.g., biller device 16A), a request for payment that indicates a payment amount requested from a payer. Biller device 16A may correspond to a biller that is requesting the payment amount from the payer. The request for payment may, in some cases, represent a request for the payer to transfer the payment amount to a biller. The request for payment may additionally, or alternatively, include information indicative of a requested payment date, information indicative of a date that the request is sent, a name of the biller, an address corresponding to the biller, a name of the payer, an address corresponding to the payer, or any combination thereof. Requests for payment may include any information corresponding to the requested payment, or the parties involved in the requested transaction.

Processing circuitry 24 may control payment system 42 to output, for display by a payer device of payer devices 18 (e.g., payer device 18A), information indicative of the request for payment. Payer device 18A may correspond to the payer that the biller is requesting the payment amount from. The information indicative of the request for payment may include the requested payment amount. This means that the requested payment amount may appear on a screen of the payer device 18A so that the payer can view the requested payment amount before agreeing to transfer funds from an account held by the payer to the biller. If the requested payment amount displayed by payer device 18A appears to be the wrong amount of money, the payer may dispute the requested payment amount with the biller.

In some examples, processing circuitry 24 may control payment system 42 to output contact information for the biller (e.g., an address and/or a payer service phone number) as part of the information indicative of the request for payment such that the payer may contact the biller in the event that the payer believes the request for payment to be in error. Additionally, or alternatively, processing circuitry 24 may output, as part of the information indicative of the request for payment, information indicative of a date that the request for payment is sent, information indicative of a date that payment is due, a name of the biller, a name of the payer, or any combination thereof.

Processing circuitry 24 may control payment system 42 to output, for display by the payer device 18A corresponding to the payer, a funding option for application to the payment amount requested by the biller in the request for payment. The funding option may, in some examples, include an amount of funds in addition to a balance of an account held by the payer and managed by a financial institution that manages computing system 10. For example, a balance of one or more accounts held by the payer may be less than the requested payment amount of the request for payment sent by the biller. In this example, the payer may pursue funding options for completing the request for payment by the requested payment date, or the payer may decide to defer the request for payment beyond the requested payment date. The funding option output to the payer device 18A may comprise funds in addition to funds currently present in one or more accounts held by the payer.

Payment system 42 may receive, from the payer device 18A corresponding to the payer, a selection of the funding option. In some examples, the selection of the funding option represents a input accepting the funding option, but this is not required. In some examples, the selection of the funding option represents a payer request for additional information corresponding to the funding option. If the payment system 42 receives a payer request for additional information corresponding to the funding option, payment system 42 may control processing circuitry 24 to output one or more additional details concerning the funding option, such as an amount of funds corresponding to the funding option.

One possible funding option is a loan. For example, to output the funding option to payer device 18A, processing circuitry 24 may control payment system 42 to output information indicative of an offer to extend a loan to the payer. In some examples, the information indicative of the offer to extend the loan to the payer that is sent to payer device 18A with the request for payment represents a message such as “payment option: flex loan” or another similar message. The initial information indicative of the offer to extend the loan that is sent to payer device 18A with the request for payment may, in some cases, omit details such as a loan amount, a loan fee, and a loan repayment plan. The initial information indicative of the offer to extend the loan may alert the payer to the option of a loan, giving the payer the option to ask for more details concerning the loan.

When payment system 42 receives a user request for more information concerning the offer to extend the loan, payment system 42 may control processing circuitry 24 to output, for display by the payer device 18A, information indicative of one or more loan amounts. Each loan amount of the one or more loan amounts may represent an amount of money (e.g., a principal) that the payer will receive if the payer accepts the offer to extend the loan. On some examples, payment system 42 sends a single loan amount to the payment system 42. The single loan amount may represent an amount of money that is sufficient to cover the requested amount of money in addition to or in combination with a balance of one or more accounts held by the payer. In some examples, payment system 42 may determine a difference between the payment amount requested in the request for payment and a balance of the one or more accounts held by the payer, and determine the loan amount to be the difference. That is, payment system 42 may set the loan amount to the exact amount necessary to complete the request for payment in combination with a balance of one or more accounts held by the payer. In some examples, payment system 42 may determine the loan amount to be greater than the difference between the payment amount requested in the request for payment and the balance of the one or more accounts held by the payer. That is, payment system 42 may select the loan amount so that the payer can complete the request for payment and still have a positive balance left in the payer's accounts. Payment system 42 may, in some cases, send more than one loan amount option to the payer device 18A so that the user can choose from the more than one loan amount option. The balance of one or more accounts held by the payer may be saved in memory 26 as a part of internal data 34.

Payment system 42 may control processing circuitry 24 to output, for display by the payer device 18A, information indicative of a loan fee corresponding to each loan amount of the one or more loan amounts output for display by payer device 18A. In some examples, the loan fee corresponding to each loan amount of the one or more loan amounts may represent a flat fee to be repaid in addition to the principal of the loan. For example, if the payer accepts a loan amount, the payer may be responsible for repaying both of the principal loan amount and the loan fee according to a repayment schedule. When payment system 42 outputs the one or more loan amounts and the loan fee corresponding to each loan amount of the one or more loan amounts, payment system 42 may output the loan amounts and loan fees for display by the payer device 18A such that each loan amount is presented proximate to the respective loan fee. This allows the user to evaluate the costs and benefits of each loan amount and compare options against each other. Each loan amount of the one or more loan amounts, the loan fee associated with each loan amount of the one or more loan amounts, and the repayment schedule associated with each loan amount of the one or more loan amounts may be stored in memory 26 as a part of loan options 32.

Payment system 42 may control processing circuitry 24 to output, for display by the payer device 18A, information indicative of a repayment plan corresponding to each loan amount of the one or more loan amounts. In some examples, the repayment plan corresponding to each loan amount of the one or more loan amounts may include a payment schedule comprising a sequence of payments that indicates a payment date and a payment amount for each payment of the sequence of payments. If the payer follows the payment schedule, the payer may fully repay the principal amount and the loan fee when the payer completes the last payment of the sequence of payments. By displaying the one or more payment schedules, payer device 18A may provide detailed information that allows the payer to see exactly when the payer will make payments in the future, and the exact amount of each payment. This information further enables the payer to determine whether to accept the loan. Payer device 18A may, in some examples, display a payment schedule corresponding to a payment amount selected by the user.

In examples where the funding option provided to the payer by the payment system 42 is an offer to extend a loan, it may be beneficial to provide information comparing the loan with one or more other options available to the payer. For example, if the payer does not complete the request for payment by the requested date, the biller may apply a late fee, and the payer may complete the request for payment by transferring the requested payment amount and the late fee to the biller after the requested date. Additionally, or alternatively, the payer may use one or more credit cards to pay the requested payment amount. These one or more credit cards may have interest rates attached to late repayment of the credit card balance. Payment system 42 may determine a cost of one or more other options available to the payer with a cost of the loan offered to the payer, and output this information for display by payer device 18A.

Payment system 42 may be configured to control processing circuitry 24 to determine an annual percentage rate (APR) associated with each loan amount of the one or more loan amounts that are presented to the payer as part of the offer to extend a loan to the payer. Since each loan amount of the one or more loan amounts is associated with a respective flat loan fee and a respective repayment schedule, it may be possible to calculate an APR corresponding to each loan amount based on the respective flat loan fee, the respective loan principal, and an amount of time that it will take to repay the loan according to the respective repayment schedule. Since unpaid credit card balances may accrue interest according to an APR set by the credit card company, it may be beneficial to for payment system 42 to calculate the APR associated with each loan amount so that the payer can compare the APR of each loan amount with the APRs of one or more credit cards available to the payer. Additionally, or alternatively, payment system 42 may be configured to control processing circuitry 24 to determine a fee corresponding to a late payment of the request for payment. This may allow the payer to compare the fee corresponding to a late payment of the request for payment with a flat fee associated with the loan. The APR for each loan amount of the one or more loan amounts may be saved in memory 26 as a part of loan options 32. The APR corresponding to each credit card of the one or more credit cards available to the user may be saved in memory 26 as part of external data 36. Additionally, or alternatively, the fec corresponding to the late payment of the request for payment may be saved to the memory 26 as a part of external data 36.

Computing system 10 may perform one or more actions to allow the payer to compare an offer to extend a loan against one or more other options. For example, the payment system 42 may be configured to control processing circuitry 24 to output, for display by payer device 18A, information indicative of the APR corresponding to each loan amount of the one or more loan amounts, information indicative of the APR corresponding to each credit account of the one or more credit accounts, and information indicative of the fee corresponding to the late payment of the request for payment. When payer device 18A displays this information for the payer to view, the payer may compare the cost of each of the one or more loan amounts with a cost of the one or more other options (e.g., late repayment and one or more credit cards). This information may help the payer to determine whether accepting the offer to extend the loan is cost-effective.

In some examples, a combination of a loan offered to the payer and a balance of one or more accounts held by the payer is sufficient to cover the payment amount requested by the biller. In some examples, a combination of a loan offered to the payer and a balance of one or more accounts held by the payer is greater than the amount requested by the biller such that the payer still has a positive account balance if the payer accepts the loan and completes the request for payment.

In examples where the payment system 42 outputs an offer to extend a loan to the payer including one or more loan amounts, the payment system 42 may receive, from payer device 18A, an input accepting the loan amount of the one or more loan amounts or an input declining the offer to extend the loan. When payment system 42 receives the input accepting the loan amount, payment system 42 may control processing circuitry 24 to update internal data 34 to add the loan amount to an account held by the payer. When the loan amount is added to the account, the payer may complete the request for payment via payer device 18A. In response to receiving a request to complete the request for payment from payer device 18A, computing system 10 may transfer funds to the biller from the account held by the payer.

When the computing system 10 receives an acceptance of a loan and/or a selection of a loan amount, payment system 42 may control processing circuitry 24 to output, for display by the payer device 18A, an option for the payer to enable automatic repayment of the loan from the account according to a repayment plan. or decline to enable the automatic repayment of the loan. When the payer enables automatic repayment, processing circuitry 24 may automatically remove payments from an account held by the payer according to the repayment plan shown to the payer before the payer accepts the loan. Automatic repayment may obviate a need for the payer to actively make payments, and decrease a likelihood that the payer will miss a payment. When the payer declines to enable the automatic repayment of the loan, the payer may actively make payments according to the payment schedule via payer device 18A.

In some examples, the payment system 42 may control the processing circuitry 24 to identify one or more outstanding rewards balances that the payer possesses. In some examples, the one or more outstanding rewards balances include a rewards balance with a financial institution that manages computing system 10 and manages an account held by the payer. In some examples, the one or more outstanding rewards balances include a rewards balance with the biller. The rewards balance with the financial institution may be saved in memory 26 as a part of internal data 34. The rewards balance with the biller may be saved in memory 26 as a part of the external data 36. In some examples, computing system 10 sends a message to biller device 16A requesting a rewards balance that the payer possesses with the biller, and computing system 10 receives a reply with the rewards balance.

Payment system 42 may control the processing circuitry 24 to output an option to apply at least some of the one or more outstanding rewards balances to the payment amount requested by the biller. Processing circuitry 24 may receive, from the payer device 18A, an input accepting the option to apply at least some of the one or more rewards balances to the payment amount. In response to receiving the input accepting the option, processing circuitry 24 may determine whether the one or more rewards balances cover the entire requested payment amount, or whether the payer must still cover a remaining portion of the requested payment amount.

When the payer accepts the option to apply a rewards balance that the payer possesses with the biller, processing circuitry 24 is configured to control payment system 42 to output, to the biller device 16A, a message indicating the application of at least some of the rewards balance that the payer possesses with the biller to the payment amount, allowing the biller to update the payment amount based on the application of the rewards balance. In some examples, computing system 10 may receive a reply from the biller device 16A indicating that the rewards balance is applied and indicating any remaining balance due.

When the payer accepts the option to apply a rewards balance that the payer possesses with the financial institution that manages the account processing circuitry 24 is configured to apply at least some of the rewards balance that the payer possesses with the financial institution to the payment amount requested by the biller. In some cases, the financial institution may deposit funds equivalent to the rewards balance into the account for application to the requested payment amount. In some cases, the financial institution may add the rewards balance to the payment when the payer completes the request for payment.

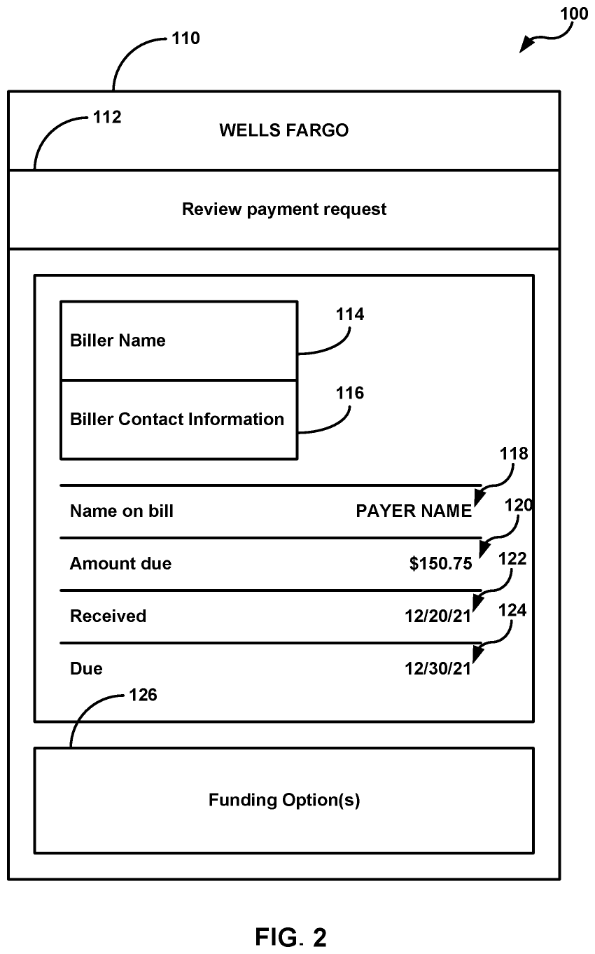

FIG. 2 is a conceptual diagram illustrating a request for payment screen 100 for display on a user interface of a device, in accordance with one or more techniques of this disclosure. As seen in FIG. 2, the request for payment screen 100 may include an area including a bank name 110, an area indicating a content of the screen 112, a biller name 114, biller contact information 116, a payer name 118, a requested payment amount 120, a date 122 that the request for payment is received, a requested payment date 124, and one or more funding options 126.

Screen 100 may be displayed by a device (e.g., payer device 18A) used by a payer subject to a request for payment from a biller. For example, the payer device 18A may represent a smart device that includes a user interface such as a touchscreen, and the payer device 18A may display screen 100 when the payer navigates to screen 100 within an application executing on the payer device 18A. In some examples, when computing system 10 receives a request for payment from biller device 16A, payment system 42 may control processing circuitry 24 to output data to payer device 18A that represents data for creating screen 100. For example, processing circuitry 24 may output the information located in the areas 114, 116, 118, 120, 122, 124, and 126 so that payer device 18A may populate screen 100 for display on the user interface. In some examples, when screen 100 is ready for display, payer device 18A may output a notification indicating that a request for payment is ready for the payer to view.

The bank name 110 may represent the name of a financial institution that manages one or more accounts available to the payer. For example, screen 100 may be part of an application managed by the financial institution that allows the payer to view information concerning the one or more accounts. The payer may decide to link the one or more accounts to one or more accounts with billers. For example, a payer may provide a bank account number to a biller (e.g., a utility company, a streaming service, a landlord) in order to transfer money to the biller. In some cases, a payer may make automatic bill payments to a biller. In some cases, the biller may send requests for payment to be reviewed and completed by the payer. The biller may, in some cases, send these requests for payment to a financial institution managing one or more accounts held by the payer. Payment system 42 may present information to a payer corresponding to a request for payment so that the payer can review the request for payment before paying the bill.

Screen 100 includes the biller name 114, biller contact information 116, the payer name 118, the requested payment amount 120, and dates 122, 124 corresponding to a request for payment so that the payer can review the request for payment before agreeing to pay the bill. For example, the payer can confirm by viewing screen 100 that the biller is a party that the payer is expecting a bill from, the payer can confirm that the request for payment is sent to the correct party, and the payer can confirm that the requested payment amount and requested payment date are correct. If any part of the request for payment is inaccurate, the payer may contact the biller based on the biller contact information 116. The biller contact information 116 may include a biller address and/or a biller phone number.

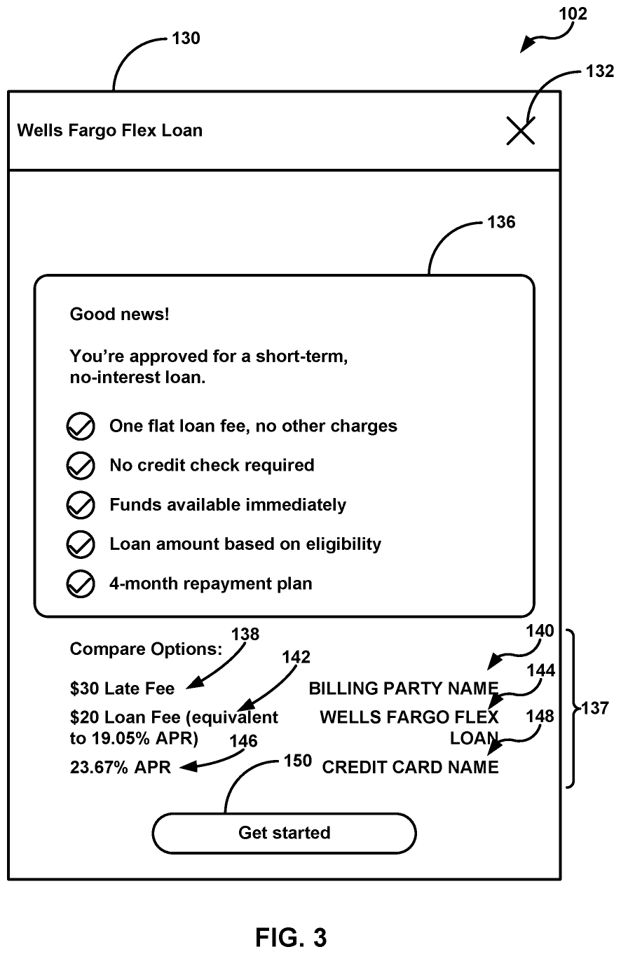

Payment system 42 may control processing circuitry 24 to output one or more funding options 126 to payer device 18A for display as part of screen 100. Funding options 126 may include an offer to extend a loan to the payer, an option to transfer funds between accounts, an option to apply one or more rewards balances to the request for payment, or any combination thereof. In some examples, payment system 42 may select the one or more funding options based on a balance of one or more accounts held by the payer. For example, if the balance of the one or more accounts is insufficient, or close to insufficient for covering the requested payment amount of the request for payment, payment system 42 may output an offer to extend a loan to the payer which would be sufficient to cover the request for payment by the requested payment date. In some examples, payment system 42 may select the one or more funding options regardless of a balance of one or more accounts. For example, payment system 42 may offer the payer one or more funding options even if accounts held by the customer are sufficient to satisfy the request for payment, or may offer the option to apply one or more rewards balances to the request for payment regardless of the balance of the account(s). In some examples, a funding option may be an offer to borrow the exact amount needed to pay off an RfP depending on the payer's account balance and the RfP amount. For example, where the payer's account balance is $250, a payer can borrow $150 to pay off a $400 RfP. In some examples, the loan fee can be prorated based on the amount needed or used by the payer. FIG. 3 is a conceptual diagram illustrating a funding option comparison and information screen 102 for display on a user interface of a device, in accordance with one or more techniques of this disclosure. As seen in FIG. 3, screen 102 includes an area 130 for describing a funding option selected by the payer, an icon 132 for exiting the selected funding option, an area 136 for funding option information, funding option comparison information 137, and a user control 150 for advancing with the funding option. The funding option comparison information 137 incudes a late fee 138 that will apply if the payer does not complete the request for payment by a requested payment date, a name of the biller 140 that will collect the late fee 138 of the request for payment is completed late, loan cost information 142, a name of the party issuing the offer to extend the loan 144, credit card cost information 146, and a name of the party managing the credit card 148.

In some examples, payer device 18A may display the screen 102 in response to a selection of a loan option of funding options 126 displayed on screen 100 (see FIG. 1). For example, computing system 10 may receive information of a request for more information concerning the loan option, and computing system 10 may send funding option information for display in area 136 and comparison information 137 for display on screen 102. The funding option information and the comparison information may aid the payer in deciding whether to proceed with the loan as a funding option.

For example, the funding information in area 136 may indicate that the payer is already approved for a loan, indicate that a credit check is not required, indicate that one flat fee applies to the loan, indicate that funds are available immediately should the payer choose to accept the loan, indicate that loan amounts are based on the payer's eligibility, and indicate that the loan is to be repaid over a certain period of time (e.g., 4 months). In this way, the funding information may represent basic information that gives the payer a picture of the benefits and responsibilities attached to the loan. The payer may, for example, evaluate whether the time period of the repayment plan is acceptable. The payer may, in some cases, decide to proceed with the loan option in light of the benefits (e.g., no credit check, funds available immediately) indicated by the funding information present in area 136.

Comparison information 137 may compare a cost of the loan option against one or more other options available to the payer. For example, the comparison information 137 may indicate that a late fee 138 associated with late completion of the request for payment is a first amount and that a flat fee associated with the loan option is a second amount. As seen in FIG. 3, the first amount may be $30 and the second amount may be $20, indicating that the loan option may be cheaper to the payer than the late repayment option. In some examples, the first amount may be less than the second amount, indicating that late repayment is cheaper to the payer than the loan option. In any case, screen 102 may present the flat cost of late repayment as compared with the flat cost of the loan fee so that the payer can make an informed decision as to whether to pursue the loan option or the late repayment option.

Additionally, or alternatively, comparison information 137 may indicate that an APR of the loan option is a first percentage and an APR of a credit card option available to the payer is a second percentage. As seen in FIG. 3, the first percentage is 19.05% and the second percentage is 23.67%. In this example, the APR of the loan option is lower than the APR of the credit card option, meaning that it may be cheaper for the payer to pursue the loan option than to complete the request for payment using the credit card. Computing system 10 may calculate the APR of the loan option based on the flat loan fee, the loan amount, and the loan repayment plan. This allows the payer to compare a cost of the loan option against a cost of the credit card option when the cost of the credit card option is given in terms of APR.

User control 150 may include a message (e.g., “Get started”) that indicates an intent to move forward with the loan option offered to the payer. If the payer clicks on the user control on the user interface of payer device 18A, the user interface of payer device 18A may display another screen that includes more information concerning the loan option. The payer also has the option to select the icon 132 to exit out of the loan option and decline to accept the loan.

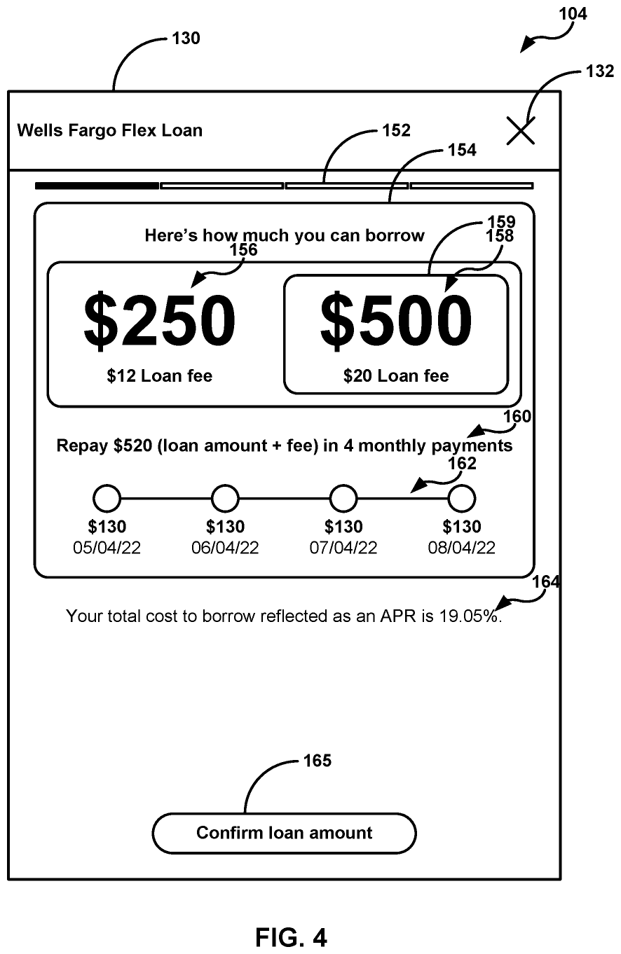

FIG. 4 is a conceptual diagram illustrating a loan offer information screen 104 for display on a user interface of a device, in accordance with one or more techniques of this disclosure. As seen in FIG. 4, screen 104 includes the area 130 for describing the loan option selected by the payer and the icon 132 for exiting the selected loan option. Screen 104 also includes a progress bar 152 indicating an amount of progress that the payer has made towards accepting the loan option. Screen 104 includes an area 154 for indicating one or more loan amounts that are selectable by a user (e.g., the payer) as part of the offer to extend the loan. Screen 104 includes a message 164 that indicates an APR of the loan option, and a user control 165 for advancing with the loan option.

The area 154 for indicating one or one or more loan amounts that are selectable by the user (e.g., the payer) may include a first loan amount option 156 and a second loan amount option 158. As seen in FIG. 4, the first loan amount option 156 includes a principal amount of $250 and a flat fee of $12, and the second loan amount option 158 includes a second principal amount of $500 and a second flat fee of $20. Selection box 159 may surround the second loan amount option 158, indicating that the second loan amount option 158 is currently selected. If the payer selects the first loan amount option 156, the selection box 159 may move from surrounding the second loan amount option 158 to surrounding the first loan amount option 156.

Additionally, or alternatively, the area 154 for indicating one or one or more loan amounts may include a message 160 indicating a total amount to be repaid and a number of payments required. The area 154 may also include a graphic 162 that specifies a payment date and payment amount for each payment required to fully repay the loan amount. Message 160 and graphic 162 may change depending on whether the first loan amount option 156 or the second loan amount option 158 is currently selected.

As seen in FIG. 4, when the second loan amount option 158 is selected, the message 160 indicates that the payer must repay a total of $520, representing the loan principal amount of $500 plus the loan fee of $20. The message 160 also indicates that the repayment plan includes four monthly payments. As seen in FIG. 4, when the second loan amount option 158 is selected, the graphic 162 may indicate four monthly payments. Each payment of the four monthly payments indicated by graphic 162 includes a payment amount and a payment date. For example, the first payment of $130 is due on May 4, 2022, the second payment of $130 is due on Jun. 4, 2022, the third payment of $130 is due on Jul. 4, 2022, and the fourth payment of $130 is due on Aug. 4, 2022. The four payments of $130 add up to $520, which is the total amount due to be repaid.

In examples where the first loan amount option 156 is selected, the message 160 and the graphic 162 may change to reflect the first loan amount option 156. For example, when first loan amount option 156 is selected, the message 160 may indicate that the payer must repay a total of $262, representing the loan principal amount of $250 plus the loan fee of $12. The message 160 may also indicate that the repayment plan includes four monthly payments. Graphic 162 may also indicate four monthly payments. For example, a first payment $65.50 may be due on May 4, 2022, a second payment of $65.50 may be due on Jun. 4, 2022, a third payment of $65.50 may be due on Jul. 4, 2022, and a fourth payment of $65.50 may be due on Aug. 4, 2022. The four payments of $65.50 may add up to $262, which is the total amount due to be repaid for the first loan amount option 156.

Message 164 indicates an APR of the selected loan amount. For example, the APR for the second loan amount option 158 is 19.05%. Payment system 42 may control processing circuitry 24 to calculate the APR for the second loan amount option 158 based on the principal amount, the loan fee, and the repayment schedule. When first loan amount option 156 is selected, screen 104 may display an APR corresponding to the first loan amount option 156.

Screen 104 may display a user control 165 for advancing with the loan option. When one of the loan amount options is selected, the user (e.g., the payer) may advance by clicking the user control 165 on the screen 104. The information included on screen 104 may help the payer decide whether to proceed with the loan option at one of the displayed loan amounts. For example, by displaying the repayment plan for the loan on graphic 162 including payment amounts and payment dates, screen 104 may provide the payer with information for evaluating whether the repayment plan is manageable for the payer.

The techniques described herein are not limited to the information amounts shown in FIG. 4. For example, screen 104 may display any payment amount, not just $250 and $500. Screen 104 may display any kind of payment plan, including plans with weekly payments, bi-monthly payments, or any other payment interval. Payment plans may have more than four payments or less than four payments.

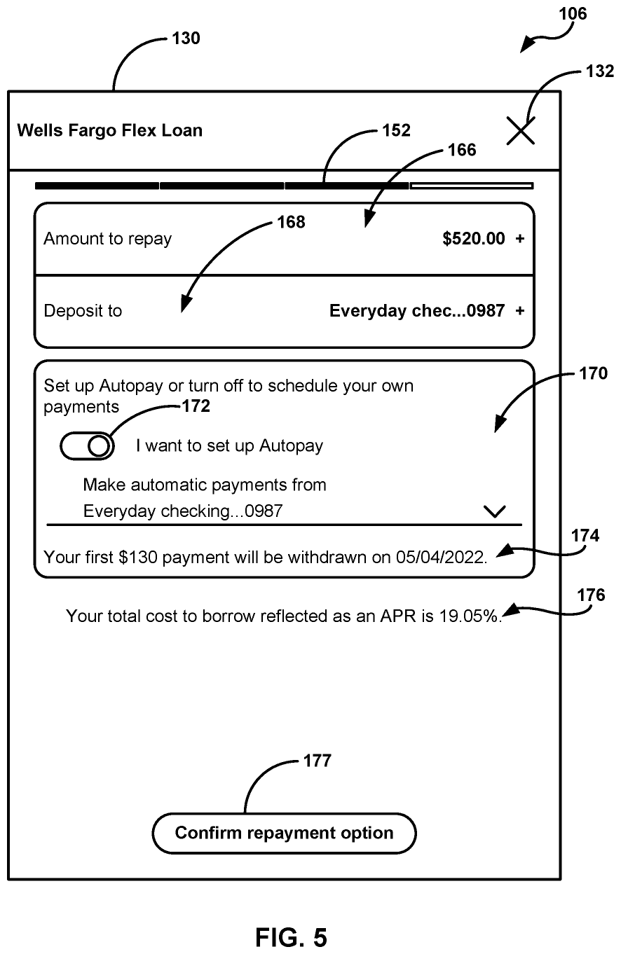

FIG. 5 is a conceptual diagram illustrating an autopay option screen 106 for display on a user interface of a device, in accordance with one or more techniques of this disclosure. As seen in FIG. 5, screen 106 includes the area 130 for describing the loan option selected by the payer and the icon 132 for exiting the selected loan option. Screen 106 also includes a progress bar 152 indicating an amount of progress that the payer has made towards accepting the loan option.

In some examples, the device (e.g., payer device 18A) may display screen 106 in response to receiving a selection of a user control on a previous screen. Progress bar 152 in FIG. 5 indicates that the payer has made significant progress towards accepting the loan option. As seen in FIG. 5, screen 106 includes an area 166 that indicates a total amount to repay and screen 106 includes an area 168 that indicates an account that the payer wishes to receive the loan principal and from which the payer wishes to make payments. Area 166 may, for example, display the amount $520 in response to a selection of the second loan amount option 158 on screen 104. If the payer selects the first loan amount option 156 or another loan amount option, area 166 may display an amount other than $520.

Area 168 may indicate an account (e.g., a checking account, savings account). In some examples, area 168 may indicate the account to which the loan amount will be deposited when the loan option is accepted. In some examples, loan payments may be made from the account displayed in area 168, but this is not required. The payer may, in some examples, make payments from accounts other than the account displayed in area 168. In some examples, Area 168 may include a user control such that the payer may select an account for deposit and/or payment. In some cases, the payer may include more than one account with the bank. When Area 168 receives a user selection (e.g., a touch input), screen 106 may display a list of accounts for selection by the payer.

Area 170 may include information concerning an autopay option, and a user control 172 for selecting or declining an autopay option for repaying the loan after the loan is accepted. The payer may accept the autopay option by clicking the user control 172, and the payer may decline the autopay option by clicking the user control 172. For example, an inner circle of user control 172 may toggle between the left side of the user control 172 and the right side of the user control 172 based on whether the autopay option is selected or not selected. Information included in area 170 may include information concerning the account that automatic payments will be withdrawn from, an indication that the payer must select whether to enable autopay, and a message 174 indicating an amount and a date of the first repayment. As seen in FIG. 5, the account indicated by message 174 is the same account as the account indicated in area 168. This means that in the example of FIG. 5, the loan amount is deposited to the same account from which automatic repayments are withdrawn. Message 176 may indicate an APR of the loan amount selected by the user (e.g., the payer).

When autopay is enabled, computing system 10 may automatically withdraw payments from the selected account according to the repayment plan shown in message 160 and graphic 162 of FIG. 4 without the payer actively making the payments. When autopay is not enabled, payments are not automatically withdrawn from one or more accounts according to the payment schedule. In this example, the payer may actively make payments according to the payment schedule from one or more accounts held by the payer. The payer might choose to make these payments from the same account that receives the loan amount, but this is not required.

Screen 106 may include a user control 177 for advancing the loan option. When the autopay option is selected when user control 177 receives an input to advance, the autopay option may be enabled. When the autopay option is not selected when user control 177 receives an input to advance, the autopay option may be disabled.

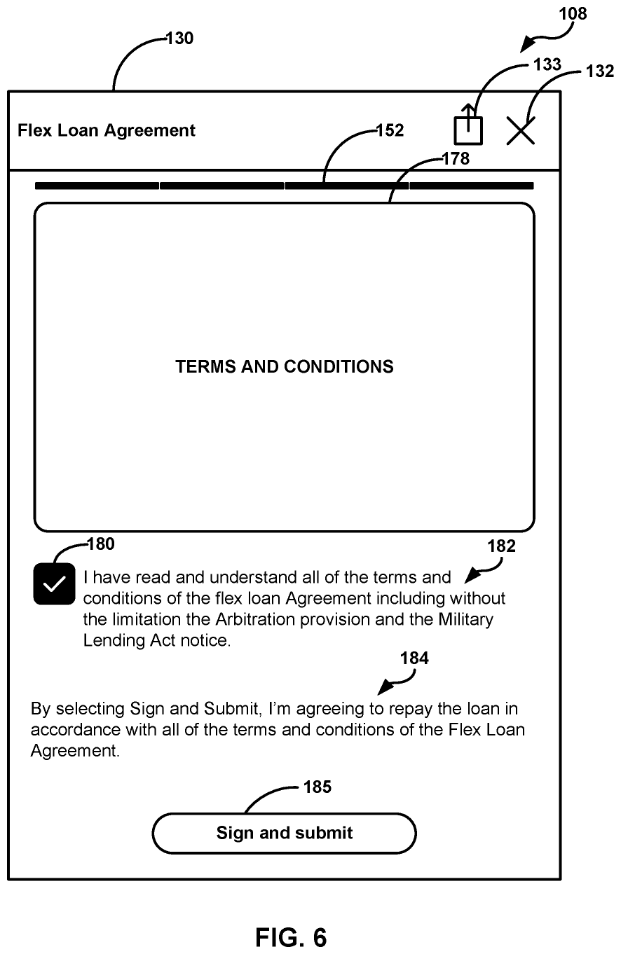

FIG. 6 is a conceptual diagram illustrating a terms and conditions screen 108 for display on a user interface of a device, in accordance with one or more techniques of this disclosure. As seen in FIG. 6, screen 108 includes the area 130 for describing the loan option selected by the payer and the icon 132 for exiting the selected loan option. Area 130 of FIG. 6 also includes icon 133 for sharing content included on screen 108. Screen 108 also includes a progress bar 152 indicating an amount of progress that the payer has made towards accepting the loan option.

Progress bar 152 of FIG. 6 indicates that the process for accepting the loan option is almost complete. Area 178 may include text representing one or more terms and conditions that attach if the payer accepts the loan. In some examples, the entire terms and conditions text might not be located in area at 178. The payer may have the option to redirect to the entire terms and conditions or download the entire terms and conditions. In some examples, the payer may scroll through the entire terms and conditions, with only part of the text being displayed by area 178 at one time.

Screen 108 may include a user control 180 that may be selected or deselected. Message 182 may be located proximate to user control 180 such that the payer may select or deselect user control 180 based on the message 182. Message 182 may include a statement that the payer has read and understood the terms and conditions that are at least partially displayed in area 178. Selecting user control 180 may indicate that the payer agrees with the statement in message 182, and deselecting user control 180 may indicate that the payer disagrees with the statement in message 182. Screen 108 also includes message 184 and user control 185. Message 184 indicates that selecting user control 185 and selecting user control 180 binds the payer to the terms and conditions that are at least partially displayed in area 178.

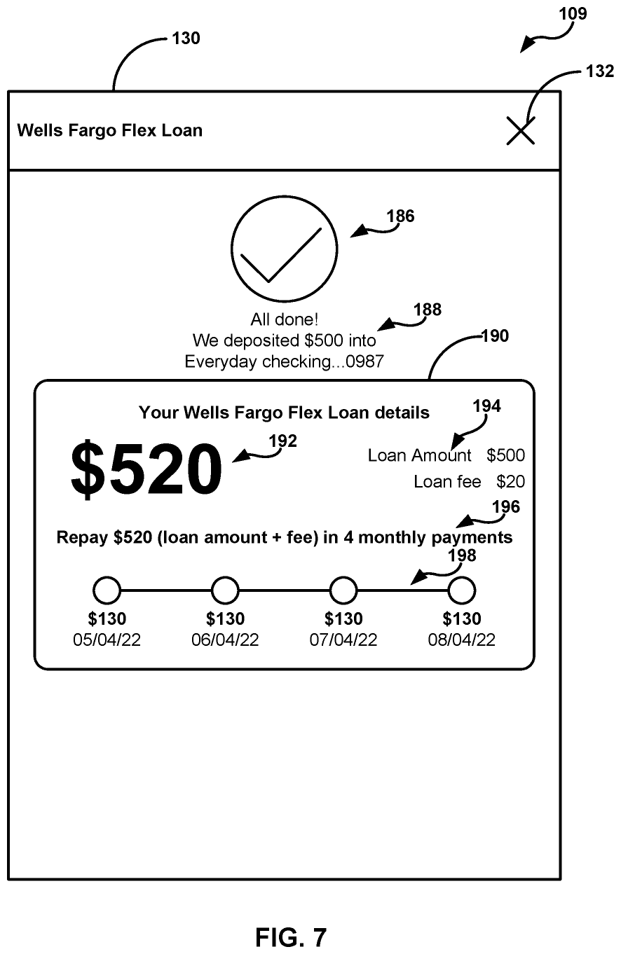

FIG. 7 is a conceptual diagram illustrating a confirmation screen 109 for display on a user interface of a device, in accordance with one or more techniques of this disclosure. As seen in FIG. 7, screen 109 includes the area 130 for describing the loan option selected by the payer and the icon 132 for exiting the selected loan option.

Screen 109 includes an icon 186 that indicates a symbol (e.g., a checkmark) which indicates that the process for accepting the option for the loan is complete. Screen 109 may additionally or alternatively include a message 188 that indicates that the process of accepting the loan is complete, and a confirmation that the loan principal amount has been deposited in the account selected by the payer. Area 190 may include one or more confirmation details concerning the loan accepted by the payer. For example, message 192 may indicate a total amount to be repaid representing a sum of a principal loan amount and the loan fec. Message 194 may indicate the principal loan amount and the loan fee. Message 196 may indicate that the total amount is to be repaid in four monthly payments. Graphic 198 may indicate a payment amount and payment date of each payment.

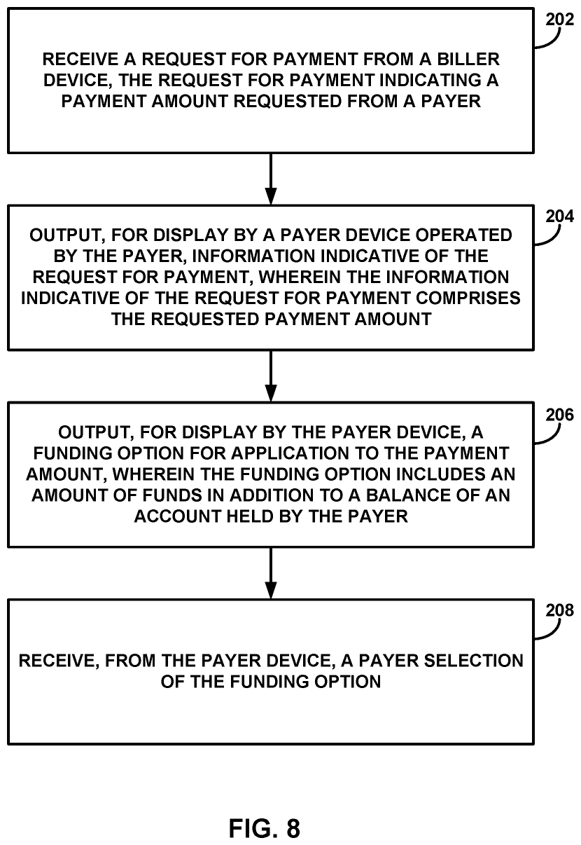

FIG. 8 is a flow diagram illustrating an example method for outputting one or more funding options for completing a request for payment, in accordance with one or more techniques of this disclosure. FIG. 8 is described with respect to computing system 10 of FIG. 1. However, the techniques of FIG. 8 may be performed by different components computing system 10 or by additional or alternative computing systems.

Payment system 42 may receive a request for payment from a biller device 16A, the request for payment indicating a payment amount requested from a payer (202). In some examples, biller device 16A may corresponding to a biller. Payment system 42 may control processing circuitry 24 to output, for display by a payer device 18A operated by the payer, information indicative of the request for payment, where the information indicative of the request for payment comprises the requested payment amount (204). The payer may view the information indicative of the request for payment on a screen of payer device 18A, and either complete or not complete the request for payment.

Payment system 42 may control processing circuitry 24 to output, for display by payer device 18A, a funding option for application to the payment amount, wherein the funding option includes an amount of funds in addition to a balance of an account held by the payer (206). For example, the requested amount may be greater than a balance of one or more accounts held by the payer. The payer may, in these cases, pursue options for completing the request for payment that involve funds in addition to the balance of the one or more accounts. Payment system 42 may, in some examples, identify that the requested payment amount is greater than the balance of one or more accounts or identify that the requested payment amount is close to the balance of the one or more accounts. Payment system 42 may output the funding option in response to this identification. In some cases, payment system 42 may output the funding option regardless of whether the requested payment amount is greater than or close to the balance of the one or more accounts.

Payment system 42 may receive, from payer device 18A, a selection of the funding option (208). In some examples, the selection of the funding option may represent a request for more information concerning the funding option. Payment system 42 may control processing circuitry 24 to output additional information concerning the funding option.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

1. A computing system comprising:
a memory; and
processing circuitry in communication with the memory, wherein the processing circuitry is configured to:
receive, from a biller device, a request for payment that indicates a payment amount requested from a payer;
identify an amount of funds available to the payer in a payer account;
output, to the biller device, a request for a rewards balance the payer holds with a biller operating the biller device;
receive, from the biller device and responsive to the request for the rewards balance, information about the rewards balance the payer holds with the biller;
generate, based on the amount of funds available and the information about the rewards balance, a modified request for payment by inserting a set of funding options into the request for payment, wherein the set of funding options comprises an offer to extend a loan to the payer and an option to apply the rewards balance the payer holds with the biller;
generate funding option comparison information for one or more of the funding options providing a comparable cost to the payer for each of the one or more funding options;
output, to the payer device and for display by the payer device in a user interface, the modified request for payment including information about each funding option of the set of funding options and the funding option comparison information;
receive, from the payer device, an indication of selection of a funding option corresponding to the option to apply the rewards balance to the payment amount and an instruction to apply at least some of the rewards balance that the payer holds with the biller;
provide the funding option of the set of funding options to the payer so that the amount of funds available to the payer in the payer account is supplemented by an amount of funds associated with the funding option of the set of funding options, wherein the supplemented amount of funds available is sufficient for the payer to complete the request for payment; and
output, to the biller device, a message indicating application of at least some of the rewards balance that the payer holds with the biller to the payment amount.

2. The computing system of claim 1,
wherein to output the information about each funding option of the set of funding options, the processing circuitry is further configured to output information about the offer to extend the loan to the payer, wherein a combination of a loan amount of the loan and the amount of funds available to the payer in the payer account is sufficient to cover the requested payment amount, and
wherein to receive the indication of selection of the funding option of the set of funding options, the processing circuitry is further configured to also receive a request for additional information about to the offer to extend the loan to the payer.

3. The computing system of claim 2, wherein based on receiving the request for the additional information, the processing circuitry is configured to:
output, for display by the payer device, information indicative of one or more loan amounts;
output, for display by the payer device, information indicative of a loan fee corresponding to each loan amount of the one or more loan amounts;
output, for display by the payer device, information indicative of a repayment plan corresponding to each loan amount of the one or more loan amounts; and
receive, from the payer device:
an input accepting a loan amount of the one or more loan amounts; or
an input declining the offer to extend the loan to the payer.

4. The computing system of claim 3, wherein the processing circuitry is configured to:
determine an annual percentage rate (APR) corresponding to each loan amount of the one or more loan amounts;
determine an APR corresponding to each credit account of one or more credit accounts held by the payer;
determine a fee corresponding to a late payment associated with the request for payment; and
output, for display by the payer device, information indicative of the APR corresponding to each loan amount of the one or more loan amounts, information indicative of the APR corresponding to each credit account of the one or more credit accounts, and information indicative of the fee corresponding to the late payment.

5. The computing system of claim 2, wherein the processing circuitry is further configured to:
output, for display by the payer device, the additional information;
receive, from the payer device, an indication of input accepting the offer to extend the loan to the payer; and
deposit, responsive to the indication of input accepting the offer and to the account held by the payer, funds corresponding to the loan.

6. The computing system of claim 5, wherein the processing circuitry is further configured to:
output, for display by the payer device in response to receiving the input accepting the offer, an option prompting the payer to:
enable automatic repayment of the loan from the account according to a repayment plan; or
decline to enable the automatic repayment of the loan; and
receive, from the payer device, an indication of selection of the option to enable the automatic repayment or decline to enable the automatic repayment.

7. (canceled)

8. (canceled)

9. (canceled)

10. The computing system of claim 1, wherein the payer possesses a rewards balance with a financial institution that manages the payer account, and wherein the indication of selection of the funding option further corresponds to an option to apply at least some of the rewards balance that the payer possesses with the financial institution, and wherein the processing circuitry is configured to:
apply the at least some of the rewards balance that the payer possesses with the financial institution to the payment amount requested by the biller.

11. The computing system of claim 1, wherein an amount of funds corresponding to the funding option comprises a difference between the payment amount requested by the biller and the amount of funds available to the payer in the payer account.

12. The computing system of claim 1, wherein an amount of funds corresponding to the funding option is greater than a difference between the payment amount requested by the biller and the amount of funds available to the payer in the payer account.

13. The computing system of claim 1, wherein an amount of funds corresponding to the funding option is less than a difference between the payment amount requested by the biller and the amount of funds available to the payer in the payer account.

14. A method comprising:
receiving, by processing circuitry from a biller device, a request for payment that indicates a payment amount requested from a payer;
identifying, by the processing circuitry, an amount of funds available to the payer in a payer account;
outputting, by the processing circuitry and to the biller device, a request for a rewards balance the payer holds with a biller operating the biller device;
receiving, by the processing circuitry and from the biller device and responsive to the request for the rewards balance, information about the rewards balance the payer holds with the biller;
generating, by the processing circuitry based on the amount of funds available and the information about the rewards balance, a modified request for payment by inserting a set of funding options into the request for payment, wherein the set of funding options comprises an offer to extend a loan to the payer and an option to apply the rewards balance the payer holds with the biller;
generating, by the processing circuitry, funding option comparison information for one or more of the funding options providing a comparable cost to the payer for each of the one or more funding options;
outputting, by the processing circuitry to the payer device and for display by the payer device in a user interface, the modified request for payment including information about each funding option of the set of funding options and the funding option comparison information;
receiving, by the processing circuitry from the payer device, an indication of selection of a funding option corresponding to the option to apply the rewards balance to the payment amount and an instruction to apply at least some of the rewards balance that the payer holds with the biller;
providing, by the processing circuitry, the funding option of the set of funding options to the payer so that the amount of funds available to the payer in the payer account is supplemented by an amount of funds associated with the funding option of the set of funding options, wherein the supplemented amount of funds available is sufficient for the payer to complete the request for payment; and
outputting, by the processing circuitry and to the biller device, a message indicating application of at least some of the rewards balance that the payer holds with the biller to the payment amount.

15. The method of claim 14,
wherein outputting the information about each funding option of the set of funding options comprises outputting information about the offer to extend the loan to the payer, wherein a combination of a loan amount of the loan and the amount of funds available to the payer in the payer account is sufficient to cover the requested payment amount, and
wherein receiving the indication of selection of the funding option of the set of funding options also comprises receiving a request for additional information about to the offer to extend the loan to the payer.

16. The method of claim 15, wherein based on receiving the request for the additional information, the method further comprises:
outputting, by the processing circuitry for display by the payer device, information indicative of one or more loan amounts;
outputting, by the processing circuitry for display by the payer device, information indicative of a loan fee corresponding to each loan amount of the one or more loan amounts;
outputting, by the processing circuitry for display by the payer device, information indicative of a repayment plan corresponding to each loan amount of the one or more loan amounts; and
receiving, by the processing circuitry from the payer device:
an input accepting a loan amount of the one or more loan amounts; or
an input declining the offer to extend the loan to the payer.

17. The method of claim 16, further comprising:
determining, by the processing circuitry, an annual percentage rate (APR) corresponding to each loan amount of the one or more loan amounts;
determining, by the processing circuitry, an APR corresponding to each credit account of one or more credit accounts held by the payer;
determining, by the processing circuitry, a fee corresponding to a late payment associated with the request for payment; and
outputting, by the processing circuitry for display by the payer device, information indicative of the APR corresponding to each loan amount of the one or more loan amounts, information indicative of the APR corresponding to each credit account of the one or more credit accounts, and information indicative of the fee corresponding to the late payment.

18. The method of claim 15, further comprising:
outputting, by the processing circuitry for display by the payer device, the additional information;
receiving, by the processing circuitry from the payer device, an indication of input accepting the offer to extend the loan to the payer; and
depositing, by the processing circuitry responsive to the indication of input accepting the offer and to the account held by the payer, funds corresponding to the loan.

19. (canceled)

20. A non-transitory computer readable medium comprising instructions that when executed cause one or more processors to:
receive, from a biller device, a request for payment that indicates a payment amount requested from a payer;
identify an amount of funds available to the payer in a payer account;
output, to the biller device, a request for a rewards balance the payer holds with a biller operating the biller device;
receive, from the biller device and responsive to the request for the rewards balance, information about the rewards balance the payer holds with the biller;
generate, based on the amount of funds available and the information about the rewards balance, a modified request for payment by inserting a set of funding options into the request for payment, wherein the set of funding options comprises an offer to extend a loan to the payer and an option to apply the rewards balance the payer holds with the biller;
generate funding option comparison information for one or more of the funding options providing a comparable cost to the payer for each of the one or more funding options;
output, to the payer device and for display by the payer device in a user interface, the modified request for payment including information about each funding option of the set of funding options and the funding option comparison information;
receive, from the payer device, an indication of selection of a funding option corresponding to the option to apply the rewards balance to the payment amount and an instruction to apply at least some of the rewards balance that the payer holds with the biller;
provide the funding option of the set of funding options to the payer so that the amount of funds available to the payer in the payer account is supplemented by an amount of funds associated with the funding option of the set of funding options, wherein the supplemented amount of funds available is sufficient for the payer to complete the request for payment; and
output, to the biller device, a message indicating application of at least some of the rewards balance that the payer holds with the biller to the payment amount.
